(19) United States
(12) Patent Application Publication
(10) Pub. No.: US 2025/0239849 A1
(43) Pub. Date: Jul. 24, 2025

(54) POWER SUPPLY DEVICE HAVING AUTOMATIC SWITCHING MECHANISM

(71) Applicant: C-MEDIA ELECTRONICS INC., TAIPEI CITY (TW)

(72) Inventors: SHAN-FONG LEONG, TAIPEI CITY (TW); CHIH-YING HUANG, TAIPEI CITY (TW)

(21) Appl. No.: 18/733,778

(22) Filed: Jun. 4, 2024

(30) Foreign Application Priority Data
Jan. 23, 2024 (TW) 113102499

(51) Int. Cl. H02J 1/10

(52) U.S. Cl. CPC H02J 1/10

(57) ABSTRACT

A power supply device having an automatic switching mechanism is provided. The power supply device includes a voltage regulator and a power converter. No transistor or switching component is connected between the voltage regulator and a load. No transistor or switching component is connected between the power converter and the load. When the power converter supplies power to the load, the voltage regulator determines whether or not to also supply power to the load based on the amount of power supplied by the power converter to the load.

### CROSS-REFERENCE TO RELATED PATENT APPLICATION

This application claims the benefit of priority to Taiwan Patent Application No. 113102499, filed on Jan. 23, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to power supply devices, and more particularly to a power supply device having an automatic switching mechanism.

### BACKGROUND OF THE DISCLOSURE

A system single chip is commonly used in everyday life, so that the energy consumption of power management systems has attracted increasing attention. Due to its complex architecture, power converters consume higher energy than voltage regulators. Therefore, after the power converter and voltage regulator are connected in parallel, a set of switching elements is added to the back end of the power converter and voltage regulator to switch the power converter and voltage regulator to supply power to the load, thereby reducing energy consumption. However, the additional switching components occupy a large area on the chip.

### SUMMARY OF THE DISCLOSURE

In response to the above-referenced technical inadequacies, the present disclosure provides a power supply device having an automatic switching mechanism, including: a voltage regulator and a power converter. A power supply end of the voltage regulator is connected to a load, and a power supply end of the power converter is connected to the load and the power supply end of the voltage regulator. When the power converter supplies power to the load, the voltage regulator determines whether or not to also supply power to the load according to the power supplied by the power converter to the load. No transistor or switching element is connected between the voltage regulator and the load and no transistor or switching element is connected between the power converter and the load.

As mentioned above, the present disclosure provides a power supply device having an automatic switching mechanism. The power supply device having an automatic switching mechanism of the present disclosure includes a voltage regulator and a power converter. The voltage regulator can decide whether or not to supply power to the load simultaneously according to the power supplied to the load by the power converter, thus switching the voltage regulator, instead of the voltage regulator continuously supplying power to the load. In this way, power consumption can be effectively saved while omitting any switching elements and switching components to save space and circuit costs.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a power supply device having an automatic switching mechanism according to one embodiment of the present disclosure;

FIG. 2 is a circuit diagram of a voltage regulator of a power supply device having an automatic switching mechanism according to one embodiment of the present disclosure;

FIG. 3 is a circuit diagram of a voltage regulator and a power converter of a power supply device having an automatic switching mechanism according to one embodiment of the present disclosure;

FIG. 4 is a schematic diagram of a current flow when a voltage regulator and a power converter of a power supply device having an automatic switching mechanism according to one embodiment of the present disclosure supply power simultaneously; and

FIG. 5 is a schematic diagram of a current flow when only a power converter of a power supply device having an automatic switching mechanism according to one embodiment of the present disclosure supplies power.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether or not a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

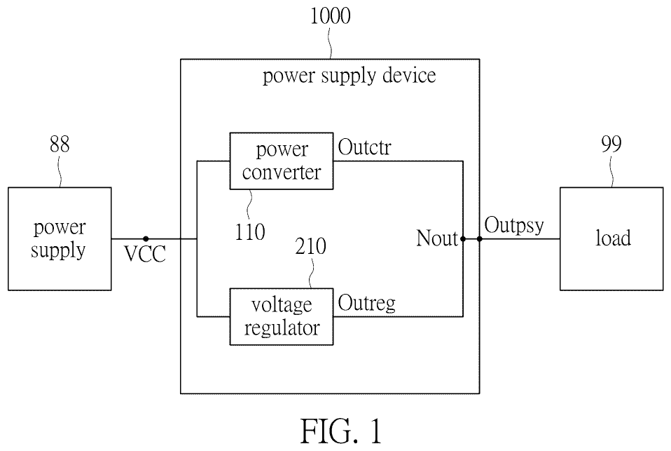

Reference is made to FIG. 1, which is a block diagram of a power supply device having an automatic switching mechanism according to an embodiment of the present disclosure.

A power supply device 1000 of the present disclosure includes a power converter 110 and a voltage regulator 210, which are connected in parallel for supplying and transmitting power to the load 99 through an output end Outpsy of the power supply device 1000, so as to supply the power required for the operation of the load 99. The load 99 described herein can be any powered device or electrical device.

It is worth noting that the power converter 110 of the power supply device 1000 of the present disclosure is not limited to any form of synchronous rectification or a combination thereof, and may include a buck converter, a boost converter, a buck-boost converter, and an inverting converter, or a combination thereof, and no transistor or switching element is connected to the load 99. The voltage regulator 210 may also include a buck converter, a boost converter or a combination thereof, and no transistor or switching element is connected to the load 99.

A power end of the power converter 110 is connected to the power supply 88. A power supply end Outctr of the power converter 110 is connected to the output end Outpsy of the power supply device 1000. The output end Outpsy of the power supply device 1000 is connected to the load 99.

A power end of the voltage regulator 210 is connected to the power supply 88. A power supply end Outreg of the voltage regulator 210 is connected to the output end Outpsy of the power supply device 1000.

It is worth noting that the power supply end Outreg of the voltage regulator 210 is further connected to the power supply end Outctr of the power converter 110, or to a node Nout or a line between the power supply end Outctr of the power converter 110 and the output end Outpsy of the power supply device 1000.

The power converter 110 may convert or modulate a common voltage VCC received from the power supply 88, such as boosting or bucking, and output a converted or a modulated common voltage VCC.

The voltage regulator 210 can adjust the common voltage VCC received from the power supply 88 to a stable voltage value to output the common voltage VCC having a stable voltage value.

Specifically, the voltage regulator 210 obtains or detects an output voltage of the power supply end Outctr of the power converter 110 to determine whether or not to supply power simultaneously to the load 99 with the power converter 110.

When the output voltage of the power supply end Outctr of the power converter 110 is not higher than a voltage threshold, the voltage regulator 210 and the power converter 110 supply power to the load 99.

On the contrary, when the output voltage of the power supply end Outctr of the power converter 110 is higher than the voltage threshold, the voltage regulator 210 does not supply power to the load 99, and only the power converter 110 supplies power to the load 99.

Alternatively, the voltage regulator 210 obtains or detects an output voltage on the node Nout or the line between the power supply end Outctr of the power converter 110 and the output end Outpsy of the power supply device 1000, and determines whether or not to supply power simultaneously to the load 99 with the power converter 110.

Specifically, when the output voltage on the node Nout or the line between the power supply end Outctr of the power converter 110 and the output end Outpsy of the power supply device 1000 is not higher than the voltage threshold, the voltage regulator 210 and the power converter 110 supply power to the load 99.

On the contrary, when the output voltage on the node Nout or the line between the power supply end Outctr of the power converter 110 and the output end Outpsy of the power supply device 1000 is higher than the voltage threshold, the voltage regulator 210 does not supply power to the load 99, and only the power converter 110 supplies power to the load 99.

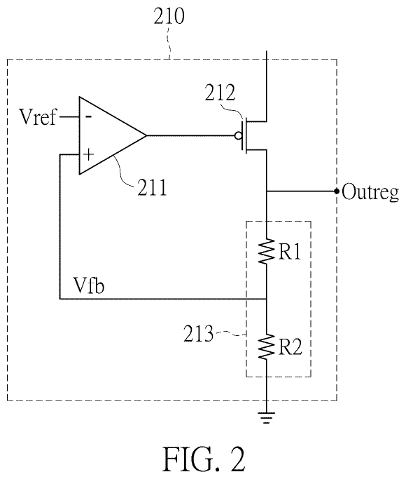

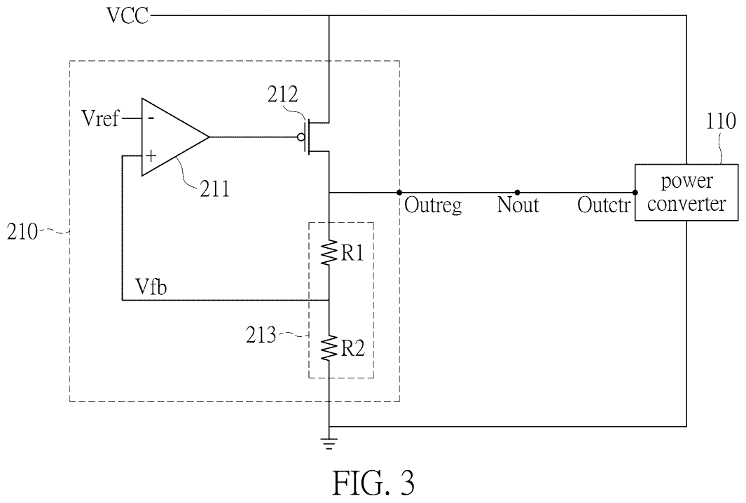

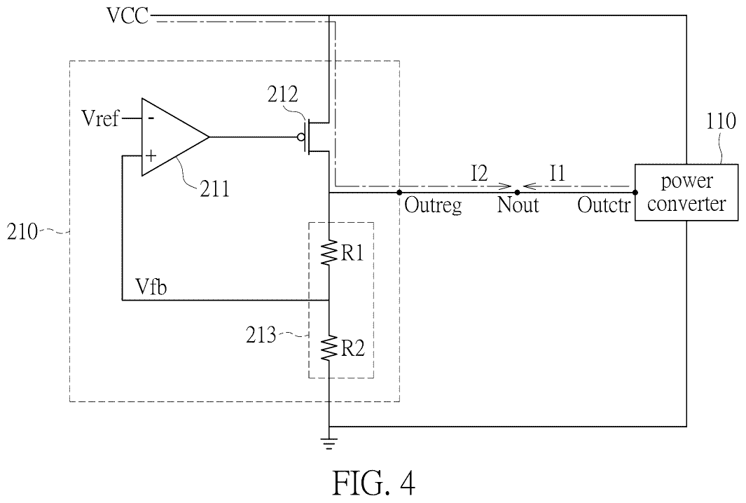

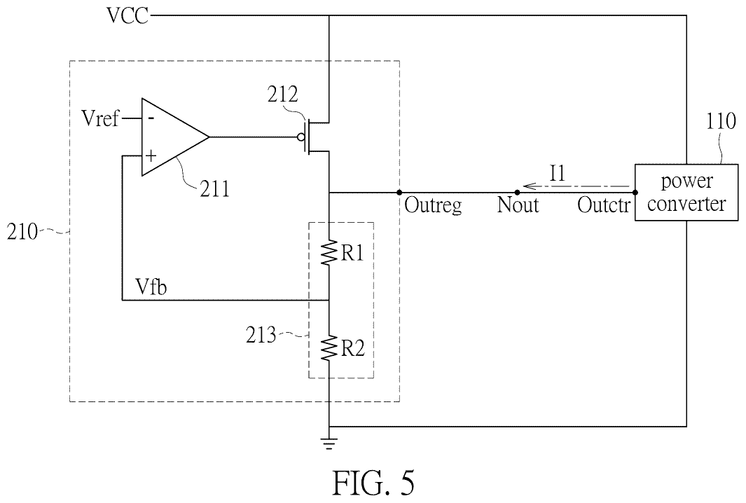

Reference is made to FIGS. 2 to 5. FIG. 2 is a circuit diagram of a voltage regulator of a power supply device having an automatic switching mechanism according to an embodiment of the present disclosure, FIG. 3 is a circuit diagram of a voltage regulator and a power converter of a power supply device having an automatic switching mechanism according to an embodiment of the present disclosure, FIG. 4 is a schematic diagram of a current flow when a voltage regulator and a power converter of a power supply device having an automatic switching mechanism according to an embodiment of the present disclosure supply power simultaneously, and FIG. 5 is a schematic diagram of a current flow when only a power converter of a power supply device having an automatic switching mechanism according to an embodiment of the present disclosure supplies power.

The voltage regulator 210 of the power supply device of the present disclosure may include an operational amplifier 211, a transistor 212 and a voltage divider circuit 213.

For example, as shown in FIGS. 2 and 3, the transistor 212 is a P-type metal oxide semiconductor field effect transistor (PMOSFET), but this is only an example and the present disclosure is not limited thereto. In practice, the transistor 212 can be replaced by other types of transistors.

The voltage divider circuit 213 may include a first resistance R1 and a second resistance R2. A first end of the first resistance R1 is connected to the node Nout or the line between the power supply end Outctr of the power converter 110 and the output end Outpsy of the power supply device 1000, or is connected to the power supply end Outctr of the power converter 110.

A first end of the second resistance R2 is connected to a second end of the first resistance R1. A second end of the second resistance R2 is grounded. A node between the first end of the second resistance R2 and the second end of the first resistance R1 is connected to a second input end of the operational amplifier 211, such as the non-inverting input end.

Voltage of the node between the first end of the second resistance R2 and the second end of the first resistance R1 is a divided voltage of the output voltage of the power supply end Outctr of the power converter 110, and is fed back as a feedback voltage Vfb to the second input end of the operational amplifier 211, such as the non-inverting input end.

The inverting input end of the operational amplifier 211 is used as the first input end and is coupled to a reference voltage Vref. The second input end of the operational amplifier 211, such as the non-inverting input end, is connected to the node Nout or the line between the power supply end Outctr of the power converter 110 and the output end Outpsy of the power supply device 1000 through a voltage divider circuit, or is connected to the power supply rnd Outctr of the power converter 110.

The operational amplifier 211 receives a divided voltage either from the output voltage at the supply end Outctr of power converter 110 or from the voltage across node Nout or the line between the supply end Outctr of the power converter 110 and the output end Outpsy of the power supply device 1000, and then calculates the difference between the divided voltage and a reference voltage Vref, amplifies the difference by a certain gain, and outputs an operational amplifier signal.

Those skilled in the art should understand that the ratio between the feedback voltage Vfb and the output voltage of the power supply end Outctr of the power converter 110 depends on the ratio of the resistance value of the second resistance R2 to the total resistance value of the first resistance R1 and the second resistance R2. The resistance values of the first resistance R1 and the second resistance R2 may depend on actual requirements, and the present disclosure is not limited thereto.

The output end of the operational amplifier 211 is connected to a control end (e.g. the gate end) of the transistor 212. The first end (e.g., the source end) of the transistor 212 can be coupled to the common voltage VCC as shown in FIG. 3, or actually connected to a power supply to receive the common voltage VCC from the power supply. The second end (e.g., the drain end) of the transistor 212 is grounded through the voltage divider circuit 213.

The transistor 212 of the voltage regulator 210 operates according to an operational amplifier signal received from the operational amplifier 211, so that an output current I2 flowing through the transistor 212 of the voltage regulator 210 to the load 99 is supplied as shown in FIG. 4 and the power supply efficiency changes with changes in the output voltage of the power supply end Outctr of the power converter 110.

As the power supply of the power supply end Outctr of the power converter 110 increases, the divided voltage of the output voltage of the power supply end Outctr of the power converter 110 that is fed back to the second input end, such as the non-inverting input end, of the operational amplifier 211 through the feedback path increases as the feedback voltage Vfb.

When the feedback voltage Vfb (which is the divided voltage of the output voltage of the power supply end Outctr of the power converter 110) received by the non-inverting input end of the operational amplifier 211 is lower than the reference voltage Vref received by the inverting input end of the operational amplifier 211, the operational amplifier 211 outputs a low-level operational amplifier signal to the control end (e.g., the gate end) of the transistor 212. As a result, the transistor 212 using a P-type metal oxide semiconductor field effect transistor (PMOSFET) is turned on by a low-level operational amplification signal. At this time, the output current I2 of the voltage regulator 210 as shown in FIG. 4 flows through the turned-on transistor 212 to the node Nout, and then flows through the power supply end Outpsy of the power supply device to the load 99 as shown in FIG. 1. Simultaneously, as shown in FIG. 4, the output current I1 of the power converter 110 sequentially flows to the node Nout, and then flows to the load 99 through the output end Outpsy of the power supply device 1000 as shown in FIG. 1.

On the contrary, when the feedback voltage Vfb (which is the divided voltage of the output voltage of the power supply end Outctr of the power converter 110) received by the non-inverting input end of the operational amplifier 211 is higher than the reference voltage Vref received by the inverting input end of the operational amplifier 211, the operational amplifier 211 outputs a high-level operational amplifier signal to the control end (e.g., the gate end) of the transistor 212. As a result, the transistor 212 using a P-type metal oxide semiconductor field effect transistor (PMOSFET) is cut off by a high-level operational amplification signal, and no output current of the voltage regulator 210 flows through the transistor 212 in the off state to the load 99. At this time, as shown in FIG. 5, only the output current I1 of the power converter 110 sequentially flows to the node Nout, and then flows to the load 99 through the output end Outpsy of the power supply device 1000 as shown in FIG. 1.

That is to say, the voltage regulator 210 can switch between the on state and the off state, and the switching condition of the voltage regulator 210 depends on the output voltage of the power supply end Outctr of the power converter 110. When the power supply end Outctr of the power converter 110 supplies enough power to the load 99, the voltage regulator 210 may stop supplying power to the load 99. On the contrary, when the power supply end Outctr of the power converter 110 cannot supply enough power to the load 99, the voltage regulator 210 also supplies power to the load 99.

As mentioned above, the transistor 212 as shown in FIGS. 2 and 3 uses a P-type metal oxide semiconductor field effect transistor (PMOSFET). In practice, the transistor 212 can be replaced by other transistors.

If the transistor 212 as shown in FIGS. 2 and 3 is replaced by an N-type metal oxide semiconductor field effect transistor (NMOSFET), the non-inverting input end of the operational amplifier 211 can be used as the first input end to be coupled to the reference voltage Vref, and the inverting input end of the operational amplifier 211 can be used as the second input end to be connected to the power supply end Outctr of the power converter 110. The output end of the operational amplifier 211 is connected to the control end (e.g. gate end) of the transistor 212.

When the feedback voltage Vfb (which is the divided voltage of the output voltage of the power supply end Outctr of the power converter 110) received by the inverting input end of the operational amplifier 211 is lower than the reference voltage Vref received by the non-inverting input end of the operational amplifier 211, the operational amplifier 211 outputs a high-level operational amplifier signal to the control end (e.g. the gate end) of the transistor 212. As a result, the transistor 212 using an N-type metal oxide semiconductor field effect transistor (NMOSFET) is turned on by a high-level operational amplification signal.

On the contrary, when the feedback voltage Vfb (which is the divided voltage of the output voltage of the power supply end Outctr of the power converter 110) received by the inverting input end of the operational amplifier 211 is higher than the reference voltage Vref received by the non-inverting input end of the operational amplifier 211, the operational amplifier 211 outputs a high-level operational amplifier signal to the control end (e.g., the gate end) of the transistor 212. As a result, the transistor 212 using an N-type metal oxide semiconductor field effect transistor (NMOSFET) is turned off by a low-level operational amplification signal.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power supply device having an automatic switching mechanism, including:
a voltage regulator, wherein a power supply end of the voltage regulator is connected to a load; and
a power converter, wherein a power supply end of the power converter is connected to the load and the power supply end of the voltage regulator;
wherein, when the power converter supplies power to the load, the voltage regulator determines whether or not to also supply power to the load according to the power supplied by the power converter to the load;
wherein no transistor or switching element is connected between the voltage regulator and the load; and
wherein no transistor or switching element is connected between the power converter and the load.

2. The power supply device according to claim 1, wherein the power converter includes a buck converter, a boost converter or a combination thereof.

3. The power supply device according to claim 1, wherein the voltage regulator is connected to a power supply.

4. The power supply device according to claim 1, wherein the voltage regulator is coupled to a common voltage.

5. The power supply device according to claim 1, wherein the power converter is connected to the power supply.

6. The power supply device according to claim 1, wherein the power converter is coupled to the common voltage.

7. The power supply device according to claim 1, wherein, when an output voltage of the power converter is not higher than a voltage threshold, the power converter and the voltage regulator simultaneously supply power to the load.

8. The power supply device according to claim 7, wherein, when the output voltage of the power converter is higher than the voltage threshold, the voltage regulator does not supply power to the load, and only the power converter supplies power to the load.

9. The power supply device according to claim 1, wherein the voltage regulator includes:
an operational amplifier, wherein a first input end of the operational amplifier is coupled to a reference voltage;
a transistor, wherein a control end of the transistor is connected to an output end of the operational amplifier, a first end of the transistor is connected to the power supply, and a second end of the transistor is connected to the power supply end of the power converter and connected to the load and the power supply end of the voltage regulator; and
a voltage divider circuit, wherein an input end of the voltage divider circuit is connected to the power supply end of the power converter, and an output end of the voltage divider circuit is connected to a second input end of the operational amplifier and configured to divide the output voltage of the power converter to output a feedback voltage to the second input end of the operational amplifier.

10. The power supply device according to claim 9, wherein the voltage divider circuit includes:
a first resistance, wherein a first end of the first resistance is connected to the power supply end of the power converter; and
a second resistance, wherein a first end of the second resistance is connected to a second end of the first resistance, a second end of the second resistance is grounded, and a node between the first end of the second resistance and the second end of the first resistance is connected to the second input end of the operational amplifier.
